(19) United States
(12) Patent Application Publication
(10) Pub. No.: US 2014/0079584 A1
(43) Pub. Date: Mar. 20, 2014

(54) CONTACT MATERIAL FOR VACUUM INTERRUPTER, AND METHOD OF MAKING A CONTACT MATERIAL

(71) Applicant: ABB Technology AG, Zurich (CH)

(72) Inventors: Reinhard SIMON, Dättwil (CH); Dietmar GENTSCH, Ratingen (DE)

(73) Assignee: ABB Technology AG, Zurich (CH)

(21) Appl. No.: 14/092,037

(22) Filed: Nov. 27, 2013

Related U.S. Application Data
(63) Continuation of application No. PCT/EP2012/002250, filed on May 25, 2012.

(30) Foreign Application Priority Data
May 27, 2011 (EP) 11004375.9

(51) Int. Cl. H01H 33/664; H01H 1/02

(52) U.S. Cl. CPC H01H 33/664; H01H 1/0206
USPC 419/38; 420/490; 427/216; 428/405; 428/404

(57) ABSTRACT

Exemplary embodiments are directed to a contact material for a vacuum interrupter, and method of making the contact material. In achieving precise control of the Si concentration of Cu/Cr contact materials, the exemplary contact material has a chromium content which is above 10 wt. % and that the material is doped with silicon below 0.2 wt. % (2000 ppm Si) and the remainder is copper Cu.

### RELATED APPLICATION

This application is a continuation under 35 U.S.C. § 120 of International application PCT/EP2012/002250 filed on May 25, 2012, designating the U.S. and claiming priority to European application 11004375.9 filed on May 27, 2011 in Europe. The content of each prior application is hereby incorporated by reference in its entirety.

### FIELD

The disclosure is related to a contact material and particularly a contact material having Cu/Cr composite materials that include the element Si in a small quantity <1 wt. % in order to achieve a high short-circuit current interruption performance of the vacuum interrupter.

### BACKGROUND INFORMATION

The predominant contact materials for vacuum interrupters can include Cu/Cr composite materials consisting of 50-75 wt. % copper and 25-60 wt. %, for example, chromium, known powder metallurgy techniques are mainly used for the production of these materials. It is known that the chemical composition of the contact material can be used for the application in vacuum interrupters. Finterstitial gas contents as well as copper-oxides and chromium-oxides should be kept as low as possible. Alumino- or silicothermic produced Cr powders are widely used as raw powder sources for the production of Cu/Cr materials. The alumino- or silicothermic method (also known as Goldschmidt-Process) is a comparable cheap technique used in the chromium metal industry. In this process the metals Al or Si or a mixture thereof is used to reduce Cr₂O₃ to Cr via the following reactions:

Cr₂O₃+2 Al→2 Cr (I)+Al₂O₃ (1)

2 Cr₂O₃+3 Si→4 Cr (I)+3 SiO₂ (2)

As a consequence of the reducing agents (Al or Si), Cr powder products contain residual contaminations of Si or/and Al in elemental and oxide form. The Cr is produced in batches in very big quantities (e.g., several tons each batch). In this technique a precise control of the Si contaminants can be difficult and in some cases impossible to achieve. As a consequence, there can be rather high variations in local Si concentration within a production batch and of course from batch to batch. This result can present severe problems for the vacuum interrupter application, where a very precise control of the Si content at ppm-level is specified. It was found experimentally that variations in Si content of the contact material, which are related to different chromium batches, can lead to a very poor and random current interruption performance.

### SUMMARY

An exemplary contact material for a vacuum interrupter is disclosed, comprising: copper Cu and chromium Cr, wherein a content of the chromium is above 10 wt. % and the material is doped with silicon below 0.2 wt. % (2000 ppm Si) and the remainder is copper Cu.

An exemplary method for making a contact material is disclosed, the contact material including copper Cu and chromium Cr, wherein a content of the chromium is above 10 wt. % and the material is doped with silicon below 0.2 wt. % (2000 ppm Si) and the remainder is copper Cu, and the method comprising: coating chromium (Cr) particles with a silicon-precursor.

### BRIEF DESCRIPTION OF THE DRAWINGS

Exemplary embodiments of the nozzle ring according to the disclosure are described in the following with reference to the drawings, in which:

FIG. 1 is a schematic drawing of a contact material microstructure in accordance with an exemplary embodiment of the present disclosure;

FIG. 2 is a micrograph drawing of a microstructure of Si-doped and sintered Cu/Cr contact material in accordance with an exemplary embodiment of the present disclosure;

FIG. 3a illustrates a polymer structure following NH3 curing in accordance with an exemplary embodiment of the present disclosure;

FIG. 3b illustrates a cross-linking reaction of the precursor layer in accordance with an exemplary embodiment of the present disclosure;

FIGS. 4a and 4b illustrate SEM micrographs of the uncoated and coated Cr powder in accordance with an exemplary embodiment of the present disclosure;

FIG. 5 a graphical summary of the different observed interruption performance of undoped and Si-doped Cu/Cr materials in accordance with an exemplary embodiment of the present disclosure;

FIG. 6 illustrates a comparison of impact strengths between two Cu/Cr materials in accordance with an exemplary embodiment of the present disclosure.

FIGS. 7a and 7b illustrate fractographs of the two materials of FIGS. 4a and 4b, respectively, in direct comparison in accordance with an exemplary embodiment of the present disclosure.

### DETAILED DESCRIPTION

Exemplary embodiments of the present disclosure enable precise control of the Si concentration of Cu/Cr contact materials. Furthermore, the Si resulting from the exemplary techniques described herein can be homogeneously distributed within the contact material in order to generate the maximum doping effect. This distribution can result in a reliable performance of vacuum interrupters at very high level, which is independent of quality variations between different Cr raw powder batches.

In accordance with the exemplary embodiments disclosed herein the chromium content can be above 10 wt. % and that the material is doped with silicon below 0.2 wt. % (2000 ppm Si) and the remainder is copper Cu. In another exemplary embodiment, the microstructure can include chromium (Cr) particles which are covered by a thin layer of silicon (Si) or Si-based material (e.g. SiOₓ).

Further advantages provided by the disclosed exemplary embodiment can include the silicon (Si) or Si-based material (e.g. SiOₓ) being located at phase boundaries between chromium (Cr) and copper (Cu) and are therefore homogeneously distributed within the microstructure. In detail, the unnotched impact bending strength of the material can be higher than 30 J/cm². Furthermore the electrical conductivity of the material can be in the range of 30-35 MS/m, for example.

According to an exemplary embodiment of the present disclosure, the chromium (Cr) particles are coated with a silicon-precursor, in order to bring in the silicon. To introduce the silicon in a very effective way, the silicon-precursor can be a polysilazane or similar Si-containing polymer.

Exemplary embodiments disclosed herein provide advantages in using mostly advantageous, a powder metallurgical process for making the contact material in the manner discussed above, that the coated Cr particles are further mixed with copper, pressed into contact shape, and finally sintered. The contact material resulting from the exemplary process can be used for contacts or contact surface coverage material for low, medium or high voltage switchgears. Furthermore, the contact material can be used for shielding, or shielding surface coverage material for medium or high voltage switchgears, such as in vacuum interrupters for medium voltage.

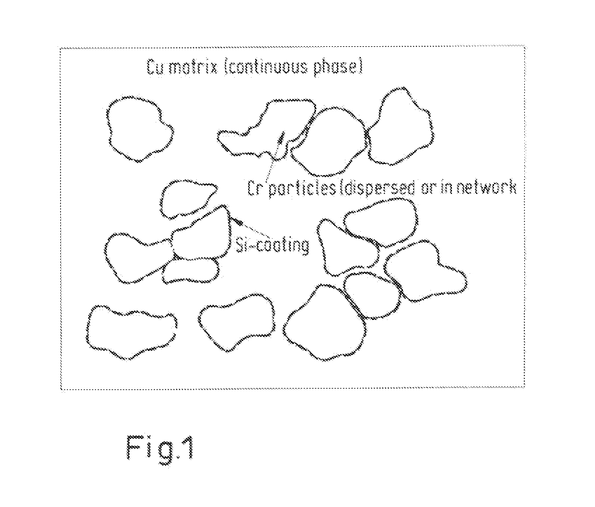

According to an exemplary embodiment of the present disclosure, the resulting material includes chromium (Cr) particles either dispersed or arranged in a network within a continuous copper (Cu) matrix phase. In another exemplary embodiment chromium (Cr) and copper (Cu) can also form an interpenetrating network of phases, depending on the content of chromium (Cr) and copper (Cu). The Cr particles or Cr phases can be covered by a silicon (Si) based coating. FIG. 1 is a schematic drawing of a contact material microstructure in accordance with an exemplary embodiment of the present disclosure. Although the overall Si content in the Cu/Cr material can be low, a homogeneous distribution of the Si dopant within the material microstructure can be present resulting from the distribution of coated Cr particles. A homogeneous doping with silicon (Si) can be realized by coating of chromium (Cr) particles by a Si-precursor.

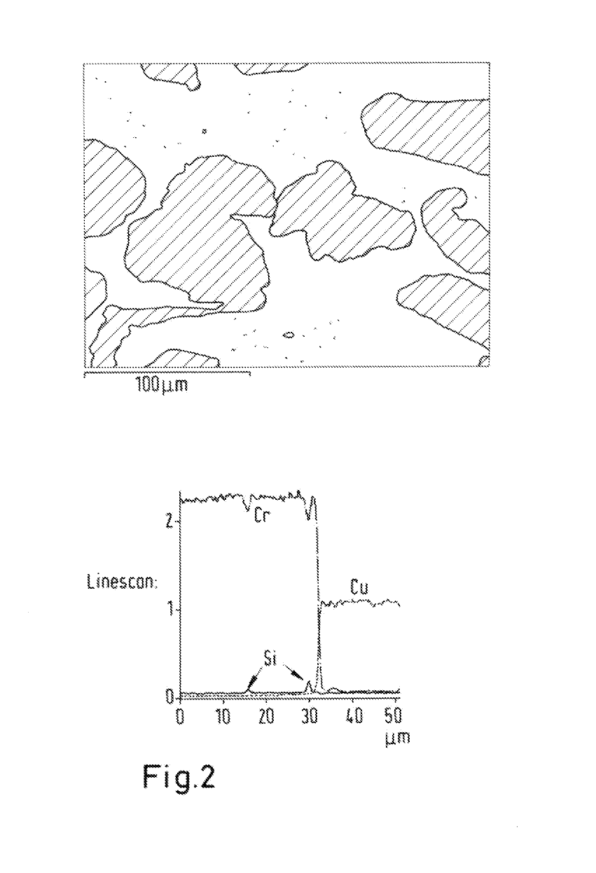

FIG. 2 is a micrograph drawing of a microstructure of Si-doped and sintered Cu/Cr contact material in accordance with an exemplary embodiment of the present disclosure. The SEM micrograph shows that Si located as a coating on Cr particles. The Si can be clearly detected at Cr/Cr and Cr/Cu interfaces by a simple EDX linescan or any or any other appropriate technique. The EDX linescan of the micrograph shows the Si at the Cr/Cr and Cr/Cu interfaces, which result from the coating of Cr particles by Si-precursor. The Cr particles are well dispersed in the Cu matrix phase and in consequence the thin Si layers located at the Cr particle surfaces result in a homogeneous distribution of Si-dopant throughout the whole microstructure. This type of doping can affect the interface properties between Cr and Cu. The described Si-doped material exhibits an improved short-circuit current interruption as well as improved mechanical and electrical performance.

According to an exemplary embodiment of the present disclosure, issues concerning distribution and precise control of Si dopant in Cu/Cr contact materials can be addressed by coating the Cr particles with a Si-precursor in a very simple wet-chemical process. In an exemplary embodiment, a polysilazane of the type PHPS (=perhydropolysilazane) can be used as Si-precursor. It should be understood that any type of polysilazane or other similar Si-containing precursor can be used to achieve the exemplary Cu/Cr microstructure of the disclosed contact material. The coating causes a very homogeneous distribution of Si in the final Cu/Cr material, which can generate a maximum doping effect. Moreover by adjusting the Si-precursor concentration, a precise control of Si content of the final Cu/Cr material can be achieved. This guarantees a reliable performance of vacuum interrupters and a stable contact material production independent of raw powder variations.

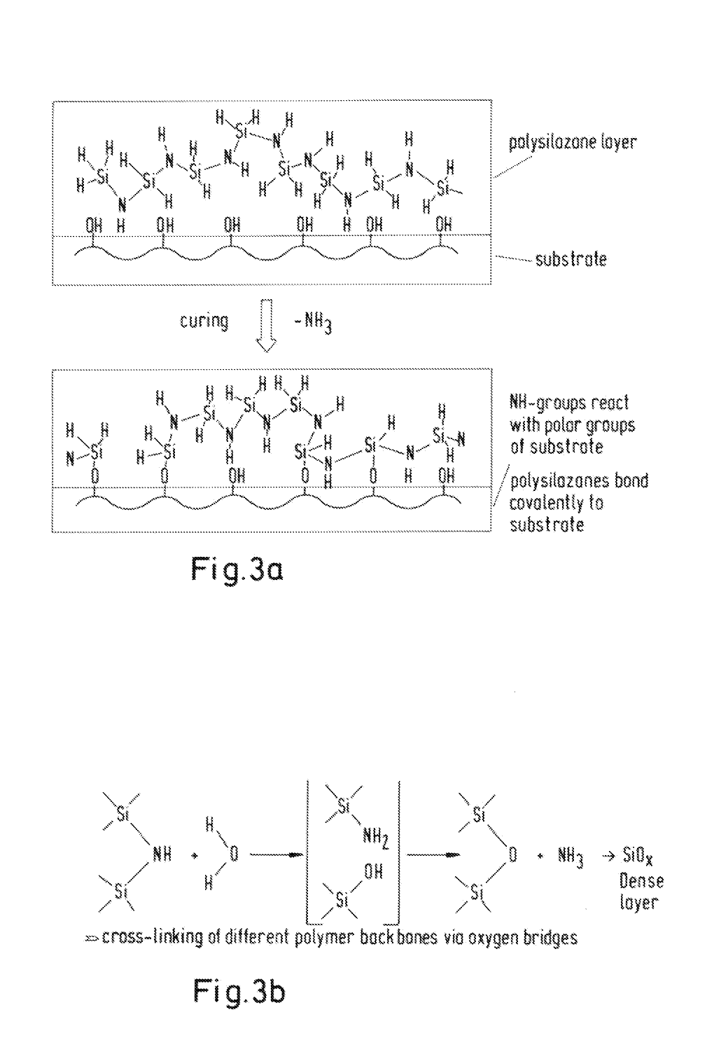

FIG. 3a illustrates a polymer structure following NH3 curing in accordance with an exemplary embodiment of the present disclosure. In accordance with an exemplary embodiment of PHPS precursor is purely inorganic. As shown in FIG. 3a, no carbon is included in the polymer structure. The PHPS is readily soluble in non-polar organic solvents, like dibutylether, giving a transparent solution of very low viscosity (similar to water). The solvent can be removable in air by evaporation. As already discussed, any polysilazane or Si-containing precursor could be used as desired.

For the coating of Cr powders diluted precursor solutions can be made. Dibutylether can be used as a solvent. The PHPS concentration in the precursor solution can be in the range of 0.5-1.5 wt. %, for example. The PHPS concentration can be adjusted to the target Si value of the final Cu/Cr material. As a result, a precise control of final Si-concentration in the ppm-range can be achieved. For the coating process, the Cr powder can be immersed in the precursor solution. The precursor reacts immediately with the particle surface forming strong chemical (covalent) Si—O—Cr bonds. After a few minutes of mixing, the dibutylether is removed by evaporation. Most of the solvent can be recovered in a condensation gap and can be reused. The resulting dry Cr powder particles are covered with a thin layer (few nm thick) of Si-precursor. Due to the fact that the drying step is performed in air, the Si-precursor layer on top of the Cr particle surface undergoes a slow cross-linking reaction which starts when the dried Cr powder comes in contact with air. FIG. 3b illustrates a cross-linking reaction of the precursor layer in accordance with an exemplary embodiment of the present disclosure. As shown in FIG. 3b, the NH-groups of the PHPS react with moisture (H₂O) in the air to form Si—O—Si cross links and gaseous ammonia (see FIG. 3b). The resulting coating on the Cr particles is transformed into a dense SiOₓ layer. The Cr powder can be immediately mixed with Cu powder and subsequently pressed and sintered to a dense Cu/Cr contact material. Alternatively the coated Cr powder can also be stored and mixed with Cu powder to a later stage in order to continue the powder metallurgy process by pressing and sintering to the final Cu/Cr contact material.

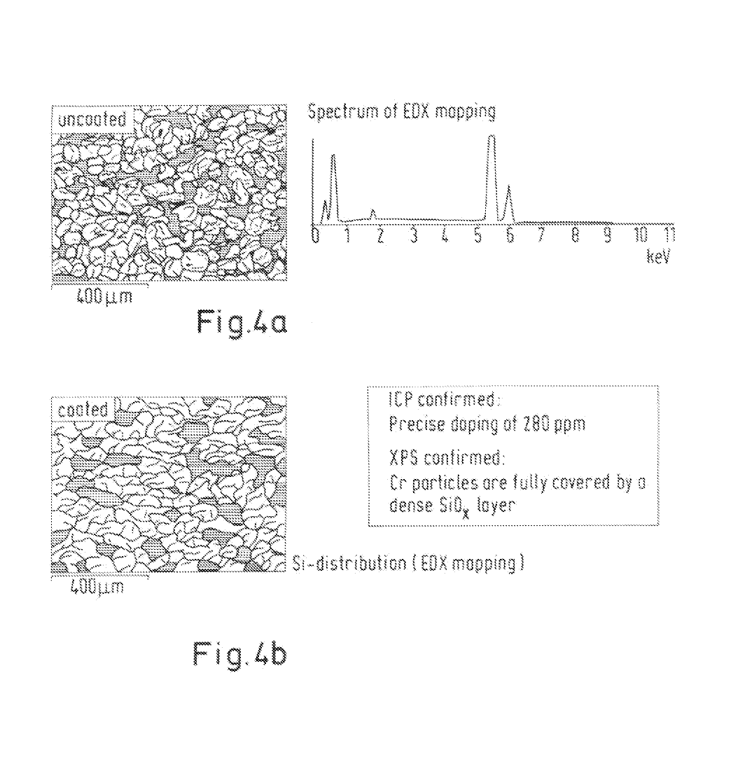

FIG. 4a illustrates SEM micrographs of the uncoated and coated Cr powder in accordance with an exemplary embodiment of the present disclosure. The coated powder exhibits a very homogeneous Si distribution covering all surface area of the Cr particles. The colour code red expresses Si in the EDX mapping. XPS measurements revealed that the PHPS precursor was transformed during a full cross-linking reaction to a dense SiOₓ layer, with x ranging from −0.9 to −1.1, for example, on the outmost surface region (4-5 nm). After the full powder metallurgy processing to a sintered Cu/Cr contact material the Si concentration was measured by ICP-OES. The measured concentration of 280 ppm Si matched the target value of 290 ppm very well. (FIG. 4b)

In the following, the main advantages of exemplary embodiments of the present disclosure are summarized briefly.
Homogeneous and precisely controllable doping of Cu/Cr materials with Si forming a thin coating of Cr particles in the final microstructure.
Homogeneous and precisely controllable doping of Cu/Cr materials with Si forming a thin coating of Cu particles in the final microstructure.
Improvement of the current interruption performance of Cu/Cr contact materials and stable control of performance independent of variations in Cr raw powder quality.
Improvement of the impact strength and fracture behaviour of Cu/Cr contact materials by strengthening of the Cu/Cr phase boundary.
High electrical conductivity of the exemplary Si-doped contact material.

In order to demonstrate the fundamental different behaviors of undoped and Si-doped Cu/Cr contact materials, two examples for both types of material are described in the following. Both materials have been processed using the same raw powder source and almost identical processing steps. The only difference in processing was in the doping with Si. One was undoped (not coated with the Si precursor) and the other was Si-doped (coated with the Si precursor). In order to evaluate the current interruption performance of contact materials, the materials were installed into commercial vacuum interrupters of the same design and tested under the same conditions. A standard three-phase electrical test procedure was performed to determine the limit in short-circuit current interruption ability.

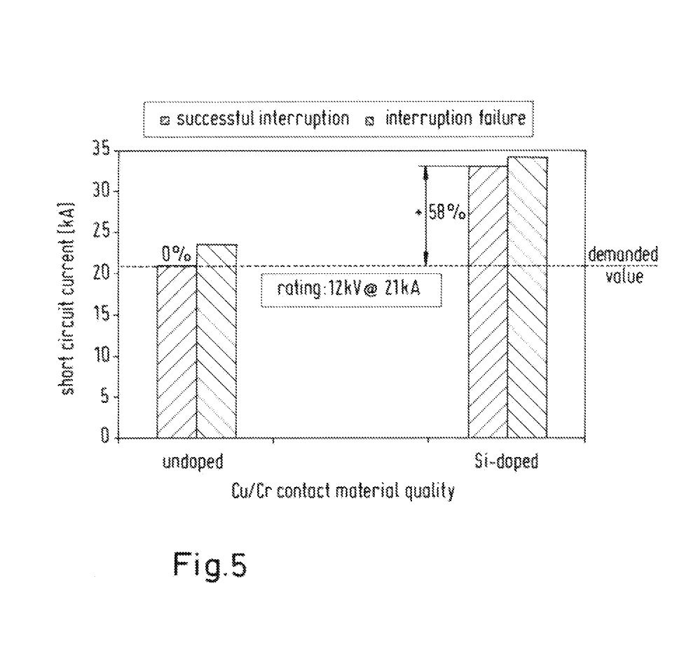

FIG. 5 a graphical summary of the different observed interruption performance of undoped and Si-doped Cu/Cr materials in accordance with an exemplary embodiment of the present disclosure. The red line in the graph marks the rated short circuit current of the used vacuum interrupter design. As shown, the undoped contact material can successfully interrupt the demanded value of 21 kA rms. However, the graph also shows an interruption failure occurring at the next increased current step at 23.6 kA rms. The material offers no safety margin. In this case the interruption performance can be susceptible to small variations in Cr raw powder quality, which can lead to interruption failure already below the demanded rating.

As FIG. 5 also shows, the Si-doped material can interrupt much higher currents. A successful interruption at a current of 33.1 kA rms is observed. This is equal to a safety margin of 58% well above the demanded rating. This outstanding performance of Si-doped material qualities is based on the exemplary material microstructures shown in FIG. 1 and FIG. 2.

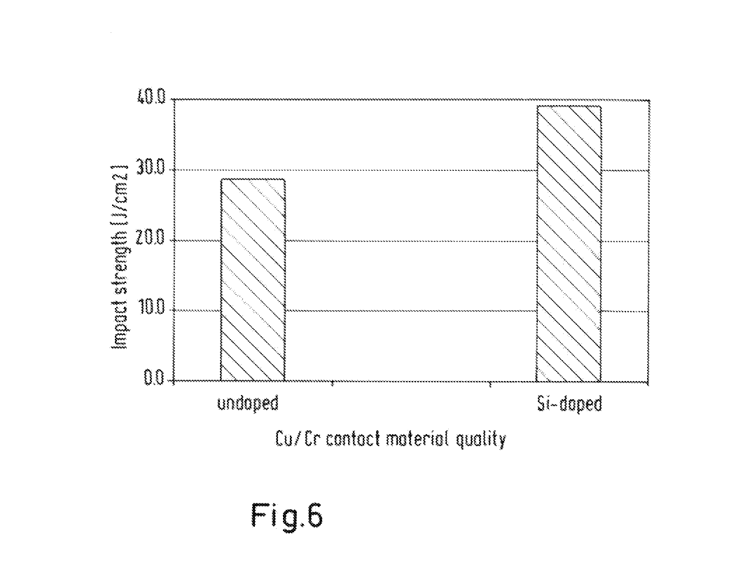

According to an exemplary embodiment of the present disclosure a further improvement of Cu/Cr contact materials can be achieved with respect to their mechanical performance. Contacts for vacuum interrupters should withstand comparable high mechanical impact loads, because of the fast opening and closing speeds at which the interrupter can be operated in service. It was found that Cu/Cr materials with Si-doping exhibit higher impact strengths compared with undoped materials. FIG. 6 illustrates a comparison of impact strengths between two Cu/Cr materials. Both materials have been processed using the same raw powder source and almost identical processing steps. The only difference in processing was in the doping with Si. One was undoped (not coated with the Si precursor) and the other one was Si-doped (coated with the Si precursor). As shown in FIG. 6, the doped material shows a significant increase in impact strength.

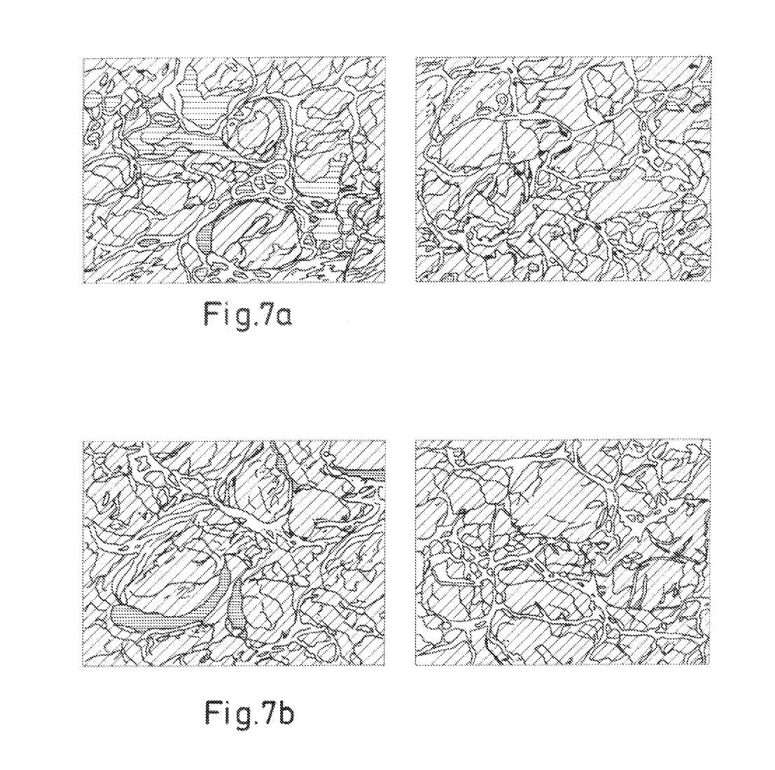

This difference in mechanical performance can be explained by the accompanying fracture surfaces. FIGS. 7a and 7b shows fractographs of both materials in direct comparison in accordance with an exemplary embodiment of the present disclosure. In the case of an undoped material, rather large gaps between Cr particles and the surrounding Cu phase are visible (see arrows in pictures), which reveal a rather poor bonding between both phases. In contrast, the Si-doped material shows an improved bonding between Cr particles and the Cu phase. This in turn leads to a pronounced trans-crystalline fracture of Cr particles.

FIG. 7a shows the fracture surface of undoped Cu/Cr contact material shows large gaps between Cr particles and Cu matrix phase. The bonding between Cr and Cu phase is comparably poor. In FIG. 7b The Si-doped Cu/Cr contact material exhibits an improved interfacial bonding between Cr and Cu phases. Therefore, the trans-crystalline fracture of Cr particles is observed.

Another important material property for the application in vacuum interrupters is the electrical conductivity of the contacts. In their major applications vacuum interrupters are operated in closed position most of the lifetime. A high electrical conductivity is of significant advantage in order to generate minimum losses under nominal currents. It is to be noted, that Si-doped Cu/Cr materials offer a comparable high electrical conductivity. This result was surprising, as usually almost all additives to copper based conductor materials lead basically to a decrease in electrical conductivity. However, the electrical conductivity of Si-doped Cu/Cr material (containing 280 ppm Si) is even higher than of the same undoped Cu/Cr material. The electrical conductivities of both materials, which have been processed are almost identical. The only difference was in the doping with Si.

### EXAMPLES

### Example 1

A chromium raw powder batch with a measured (by ICP) Si content of 88 ppm was used as starting material. The target value of Si concentration in the final Cu/Cr contact material was set to be 290 ppm. A concentrated solution of 20 wt. % PHPS precursor was further diluted to 1.00 wt. % PHPS by addition of dibutylether. 1000 g of chromium powder was added to 128.0 g of the diluted precursor solution and mixed for a short period (<30 min). After this the dispersion is dried by removal of the dibutylether solvent by rotational evaporation at a pressure of 40 mbar and a temperature of 60° C. for approximately 1 hour. After this treatment the dry Cr powder was mixed with Cu powder in the ratio 25 wt. % Cr to 75 wt. % Cu. After pressing the Cu/Cr powder mixture and final sintering to a dense contact material the Si content was determined (by ICP) to be 280 ppm. The Si is homogeneously distributed within the sintered microstructure. The Si can be located at the phase boundary between Cr and Cu.

### Example 2

A chromium raw powder batch with a measured (by ICP) Si content of 52 ppm was used as starting material. The target value of Si concentration in the final Cu/Cr contact material was set to be 600 ppm. A concentrated solution of 20 wt. % PHPS precursor was further diluted to 1.40 wt. % PHPS by addition of dibutylether. 1000 g of chromium powder was added to 232.0 g of the diluted precursor solution and mixed for a short period (<30 min). After this step, the dispersion is dried by removal of the dibutylether solvent by rotational evaporation at a pressure of 40 mbar and a temperature of 60° C. for approximately 1.5 hours. After this treatment, the dry Cr powder was mixed with Cu powder in an exemplary ratio of 25 wt. % Cr to 75 wt. % Cu, for example. After pressing the Cu/Cr powder mixture and final sintering to a dense contact material, the Si content was determined (by ICP) to be 589 ppm. The Si is homogeneously distributed within the sintered microstructure. The Si can be located at the phase boundary between Cr and Cu.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A contact material for a vacuum interrupter, comprising:
copper Cu and chromium Cr,
wherein a content of the chromium is above 10 wt. % and the material is doped with silicon below 0.2 wt. % (2000 ppm Si) and the remainder is copper Cu.

2. The contact material according to claim 1, wherein a microstructure includes chromium (Cr) particles which are covered by a thin layer of silicon (Si) or Si-based material.

3. The contact material according to claim 1, wherein a microstructure includes Copper (Cu) particles as a Copper-powder, and the particles are covered with thin layers of Silicone (Si) or Si-based material.

4. The contact material according to claim 1, wherein the silicon (Si) or Si-based material is located at phase boundaries between the chromium (Cr) and copper (Cu) and is therefore homogeneously distributed within the microstructure.

5. The contact material according to claim 1, wherein the Silicon or Si-based material is a mixture of coated Chromium and Copper powder.

6. The contact material according to claim 1, wherein an impact bending strength of the material is higher than 30 J/cm².

7. The contact material according to claim 6, wherein the material is a contact or contact surface coverage material for low, or medium or high voltage switchgears.

8. The contact material according to claim 1, wherein an electrical conductivity of the material is higher than 33 MS/m.

9. The contact material according to claim 8, wherein the material is a contact or contact surface coverage material for low, or medium or high voltage switchgears.

10. The contact material according to claim 1, wherein the copper content includes copper particles that are coated with Si precursor.

11. The contact material according to claim 10, wherein the material is a contact or contact surface coverage material for low, or medium or high voltage switchgears.

12. The contact material according to claim 10, wherein the contact material is a shield, or shielding surface coverage material for low, medium or high voltage switchgears.

13. The contact material according to claim 1, wherein both selected powders are coated with Si precursor.

14. The contact material according to claim 13, wherein the contact material is a shield, or shielding surface coverage material for low, medium or high voltage switchgears.

15. A method for making a contact material including comprising copper Cu and chromium Cr, wherein a content of the chromium is above 10 wt. % and the material is doped with silicon below 0.2 wt. % (2000 ppm Si) and the remainder is copper Cu, the method comprising:
coating chromium (Cr) particles with a silicon-precursor.

16. The method for making the contact material according to claim 15, wherein the silicon-precursor is a polysilazane.

17. The method for making the contact material according to claim 15, comprising:
mixing in a powder metallurgical process for making the contact material, the coated Cr particles with copper,
pressing the mixture into a contact shape; and
sintering the contact shape.

18. The method for making the contact material according to claim 15, wherein a microstructure includes chromium (Cr) particles which are covered by a thin layer of silicon (Si) or Si-based material.

19. The method for making the contact material according to claim 15, wherein a microstructure includes Copper (Cu) particles as a Copper-powder, and the particles are covered with thin layers of Silicone (Si) or Si-based material.

20. The method for making the contact material according to claim 15, wherein the silicon (Si) or Si-based material is located at phase boundaries between the chromium (Cr) and copper (Cu) and is therefore homogeneously distributed within the microstructure.
